(19) United States
(12) Patent Application Publication
(10) Pub. No.: US 2008/0122986 A1
(43) Pub. Date: May 29, 2008

(54) Method and system for live video production over a packeted network

(76) Inventor: Florian Diederichsen, Haag a. d. Amper (DE)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/522,993

(22) Filed: Sep. 19, 2006

(51) Int. Cl. H04N 5/268

(52) U.S. Cl. 348/705; 348/E05.057

(57) ABSTRACT

A method (and system) for live video production upon video signals transported over a packeted network, includes a master clock providing a packeted time code signal to the packeted network, and a video source having a source clock that is synchronized to the master clock based upon the packeted time code signal from the master clock.

### BACKGROUND OF THE INVENTION

1. Field of the Invention

The present invention generally relates to live video production systems. More particularly, the present invention relates to a method and system for performing live video production upon video signals transmitted over a packeted network.

2. Description of the Related Art

Conventional video production facilities, such as, for example, a television studio, a cable broadcast facility, a commercial production facility, or a linear video editing bay, amongst other specialized video equipment, all rely upon, for example, the use of a video production switcher (also called a “video switcher”, “video mixer” or a “vision mixer”). A video production switcher is conventionally used in state of the art video production systems. These conventional vision mixer systems include a control panel that includes various user interfaces, such as, for example, buttons, transition (or “T-bars”), rotary knobs, and the like. The control panel receives commands from these user interfaces from a user to control a switcher processor that is in communication with the control panel.

A conventional switcher processor may switch between input video signals to provide a “produced” output video signal. In addition to performing a “hard cut” (switching directly between two input signals), mixers may also provide a variety of transitions, from simple dissolves to pattern wipes. A typical conventional switcher processor may include, for example, 80 inputs, 4 outputs, 8 monitor outputs, and the like. Each of these 80 inputs requires 80 separate and independent cables to individually carry a single video signal to the switcher processor. Each of the 4 outputs similarly requires 4 separate and independent cables to individually carry a single video signal out of the switcher processor.

Today post-production is based widely on digital non-linear editing with computers using various file formats to transfer video footage between available machinery. This scenario has rapidly replaced the formerly used acquisition, edit, and distribution of content via video tape. The computer industry has made this possible by introducing faster machines and networks with the necessary bandwidth to even handle “High Definition” (HD) streams of uncompressed content.

Live video production typically still uses much of the conventional video tape handling equipment, albeit video cassette recorders may have been replaced by disc based recorders mainly for security and ease of use.

However, video signals in these conventional video production systems are still transferred over lines that are individually dedicated to each signal to specialized machinery, which manipulates or routes the video.

These conventional, live video production systems rely upon equipment that is specially designed and dedicated to carry individual video signals upon individually dedicated signal lines. In other words, each video signal is carried upon a dedicated video cable.

Similarly, for every input and output video signal to and from a video switcher, video cables that are individually dedicated to carrying only one video signal must be provided. Each of these video cables must be connected to associated patch bays, video routers, and the like.

Since many video production systems are required to simultaneously process a large number of video signals, a large number of video cables are required to handle all of these video signals.

Further, the number of video cables in these conventional video production systems remains static, even though the number of video signals that are actually being processed by theses systems change. When these video systems handle a small number of video streams, then the video cables which are not being used by the video streams are wasted. On the other hand, the number of video cables also limits the number of video signals, which are capable of being processed by the system. These systems are not capable of processing more video signals, than the number of video inputs which are available to receive these signals.

Additionally, even when multiple video signals are being handled by these conventional systems, a particular video production may only require access to and/or processing of a small number of video signals. For example, a conventional video production system may include a switcher that handles fifty video signals carried on fifty separate video cables that are connected to the switcher. However, a video producer may only be interested in two of these fifty video signals. The remaining forty-eight signals are not necessary. Thus, these conventional video production systems often times carry more video signals than are necessary, which further leads to wasted resources, such as extraneous cabling, switching capacity overhead, and other infrastructure.

The amount of cabling required in these conventional systems is extremely large and maintenance, cost of installation, and the like, of such systems are very high.

Since video production systems combine various video signals such as video tape player signals and video camera signals, it is important that all of the sources are properly synchronized. Conventional production systems rely upon a sync generator that feeds all of the equipment. Sync (i.e. synchronization) is, therefore, generally achieved by sending out a black burst signal. This method is called “genlock.” This requires yet another cable per piece of equipment for the distribution of a synchronization signal from a generator to the equipment that needs to be synchronized. Signals which cannot be synchronized (either because they originate outside the facility or because the particular equipment does not accept an external sync) must go through a frame store synchronizer.

It is desirable to obviate the necessity of providing an independent and distinct video cable for each individual and distinct video signal in a video production environment while maintaining the ability to synchronize the video signals so that live video production may be performed.

Furthermore, troubleshooting and monitoring existing video production equipment is difficult, because yet another run of cabling (probably Ethernet or data) is required to the different pieces of equipment to collect status information.

### SUMMARY OF THE INVENTION

In view of the foregoing and other exemplary problems, drawbacks, and disadvantages of the conventional methods and structures, an exemplary feature of the present invention is to provide a method and structure in which live video production may be performed upon video signals which are transported across a packeted network.

In a first exemplary aspect of the present invention, a system for live video production on video signals over a packeted network includes a packeted network, a master clock providing a packeted time code signal to the packeted network, a video source having a source clock that is synchronized to the master clock based upon the packeted time code signal from the master clock.

In a second exemplary aspect of the present invention, a video source for use in live video production on video signals over a packeted network includes a source clock, and a clock adjuster that adjusts the source clock based upon a propagation delay between the video source and a master clock across the packeted network.

In a third exemplary aspect of the present invention, a video production switch for use in live video production on video signals received via a packeted network includes a buffer that receives video signal packets from a plurality of video sources via the packeted network, and a transformer that synchronizes the video signals from the video signal packets based upon time codes. The video signal packets include time codes that indicates a time indicated by a corresponding video source clock.

In a fourth exemplary aspect of the present invention, a method for live video production on video signals over a packeted network includes providing a packeted master clock time code to the packeted network from a master clock, and synchronizing a video source clock at a video source to the master clock based upon the packeted master clock time code.

In a fifth exemplary aspect of the present invention, a method for live video production on video signals over a packeted network includes providing a packeted master clock time code to the packeted network from a master clock, determining a propagation delay across the packeted network between the master clock to a video source, and synchronizing a video source clock at the video source to the master clock based upon the propagation delay.

In a sixth exemplary aspect of the present invention, a method for live video production on video signals over a packeted network includes providing a packeted master clock time code to the packeted network from a master clock, determining a propagation delay from a first video source to a production switch based upon the time code and an arrival time of a video signal from the first video source, and synchronizing the video signal from the first video source at the production switch to a second video signal received from a second video source.

An exemplary embodiment of the present invention uses standard packeted networks (e.g. based on Internet protocol networks, like standard Ethernet) for the distribution and manipulation of live video. In this manner, the cost of infrastructure is greatly reduced without sacrificing security or handling.

An exemplary embodiment of the present invention replaces the conventional dedicated video production systems which have enormous infrastructure costs with a scalable, modular, smaller, less costly, and general purpose hardware which incorporate the features of the present invention.

An exemplary embodiment of the present invention may receive a serial digital interface (SDI) video signal or a high-definition serial digital interface (HD-SDI) video signal and convert that signal into packets that are capable of being transported across a packeted network. The data carried by the video signal is divided into packets and each packet is tagged with the time, date, and an identifier unique to the video source at the video source. Since the clock at the video source is synchronized to a master clock, the video signal from the video source is synchronized with all other video signals provided by other video sources which are also synchronized to the same master clock.

Many video production companies have two separate systems. These companies have a dedicated, stand alone, infrastructure heavy and expensive video production system, but may also have a packeted network system which is independent of the video production system. An exemplary embodiment of the invention may incorporate the video production system onto a packeted network thereby greatly reducing and/or eliminating the cost for dedicated maintenance and repairs on the video production system because the existing maintenance and repair capabilities of the packeted network may now be used for maintaining the video production capabilities.

An exemplary embodiment of the present invention modifies an existing packeted network to enable that network to perform video production functions.

An exemplary embodiment of the present invention has many advantages, such as, for example, the use of standard cabling, a scalable architecture, which provides for easily expandable switchers, video monitors available at every network patch, only the needed bandwidth is cabled, there is no need for distribution amplifiers and one cable per signal, the format is independent, big and expensive routers are no longer needed, and existing network topology, technology, and architecture may be used.

An exemplary embodiment of the present invention is capable of sharing the bandwidth of a small number (or one) network cable(s) by multiple video signals. This drastically reduces the number of cables which are required by the inventive video production system in comparison with conventional systems.

An exemplary embodiment of the present invention is capable of selecting between a large number of video content sources, regardless of the number of cables which are present in the system. The only limitation to the present invention may be the bandwidth of the network over which the present invention operates. However, as the bandwidth of continuously developing networks increases, this limitation is becoming less restrictive.

An exemplary embodiment of the present invention provides additional capabilities which are not available to conventional video production systems. For example, an exemplary embodiment of the invention may be capable of encoding the video in different ways, incorporating metadata into the video stream, and the like. This metadata may include various information, for example, camera and lens type, positioning of the camera, live active frame-synced tracking of all degrees of freedom for the camera, including zoom and focus, statistical data collected by a scout at the camera position, results of various forms, external clocks (e.g. game clocks in sports) and many more.

An exemplary embodiment of the present invention includes a timing synchronization method for synchronizing the clocks at multiple video sources that provide video content on the packeted network. This embodiment may establish a master clock and each source may then communicate with the master clock to determine a propagation delay between the source and the master clock. This measurement of the propagation delay may then be used to synchronize the clocks at each of the sources with the master clock and/or with other sources.

In contrast to the present invention, conventional video production systems rely upon a master clock signal that is provided upon yet another dedicated signal line. Such conventional systems may provide a blank video burst on that signal line and the video system may then synchronize the video sources to the timing of this blank video burst. These systems, therefore, require yet another cable, which provides the synchronizing source to the video production system, in addition to all of the video cables which are individually dedicated to each separate incoming and outgoing video stream. The present invention obviates the necessity of providing this additional cable.

An exemplary embodiment of the present invention allows for easy tracking of status and troubleshooting of all connected equipment by using the packeted network to not only transport video signals, but also to transmit health conditions of the equipment that is connected to the network in communication with a central console, which displays the state of all connected equipment in an easily understandable format.

An exemplary embodiment of the present invention may include network endpoints that are capable of converting and injecting various existing file formats into the production network for easy connection of existing video servers and similar equipment.

An exemplary embodiment of the present invention may encrypt video at the source using a video encryption system. This allows producers to distribute all signals around a facility (e.g. an Olympics broadcast center) and sell direct access to the various video sources to their customers without employing a costly and manpower intensive patch infrastructure.

An exemplary embodiment of the present invention may use third party watermarking software to protect a video signal at the source.

An exemplary embodiment of the present invention may emulate existing patch panels by providing multiple network ports, which either transport all networked video signals or output only one configured signal. For example, the output ports may be a 19″ network switch, which only presents one network address at each port. This allows for patch panels, where they are convenient and an operation does not want to rely on reconfiguration of the used equipment.

An exemplary embodiment of the present invention incorporates metadata into the video signal. Existing video production infrastructures do not allow for the simple inclusion of ancillary data. There exists lots of data, which would greatly benefit from being indelibly linked to a stream of video, such as, for example, information about the day of recording, positioning of the camera (both tracking information as positioning in the cameraplan), statistical data for sports, results for sports and the like. This exemplary embodiment incorporates metadata like this into the video signal packets.

An exemplary embodiment of the present invention incorporates audio data into the packetized video signal, therefore, obviating the need for separate audio cabling.

An exemplary embodiment of the present invention notes the offset between a video source and a time code from a master clock and synchronizes the video signal from the video source to other video sources based upon the noted offset.

These and many other advantages may be achieved with the present invention.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates one exemplary embodiment of a system 100 for live video production over a packeted network in accordance with the present invention;

FIG. 2 illustrates one exemplary embodiment of a video source 102 for the system 100 of FIG. 1;

FIG. 3 illustrates one exemplary embodiment of a production switcher 106 for the system 100 of FIG. 1;

FIG. 4 is a flowchart 400 illustrating one exemplary method for synchronizing time codes from a video source clock to a master clock on a packeted network in accordance with one exemplary embodiment of the present invention;

FIG. 5 illustrates an exemplary hardware/information handling system 500 for incorporating the present invention therein;

FIG. 6 illustrates signal bearing media 600 and 602 (e.g., storage medium) for storing steps of a program of a method according to the present invention; and

FIG. 7 is a timeline illustrating an exemplary operation in accordance with the present invention.

### DETAILED DESCRIPTION OF EXEMPLARY EMBODIMENTS OF THE INVENTION

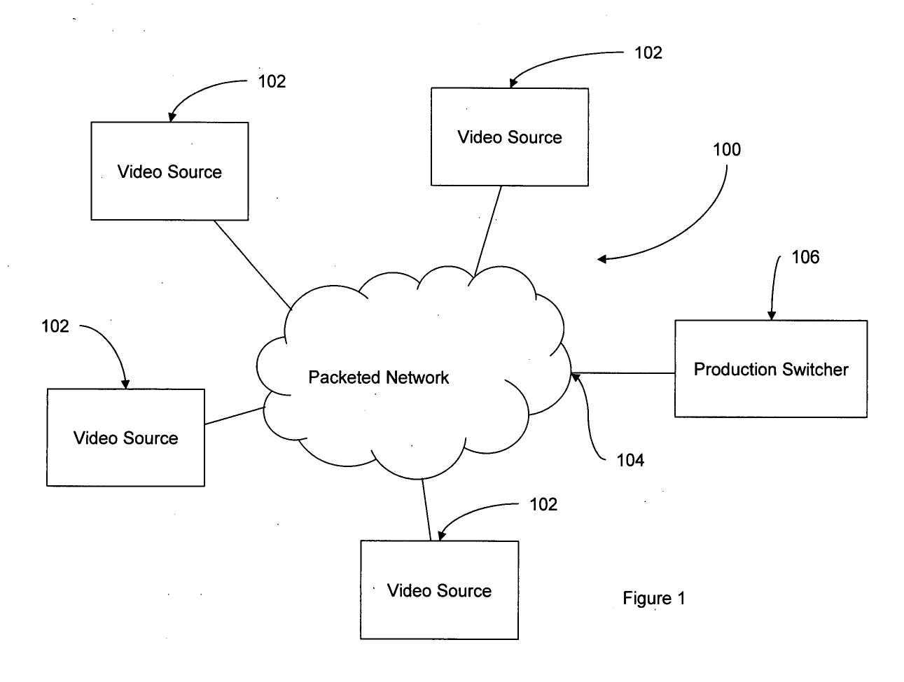

Referring now to the drawings, and more particularly to FIGS. 1-7, there are shown exemplary embodiments of the method and structures of the present invention.

FIG. 1 illustrates one exemplary embodiment of a system 100 for live video production over a packeted network in accordance with the present invention. The system 100 includes video sources 102 and a production switcher 106 in communication with a packeted network 104. The packeted network 104 may be any packeted network such as, for example a variable-latency, packeted-network, a wide-area network, a local area network, the Internet, or the like.

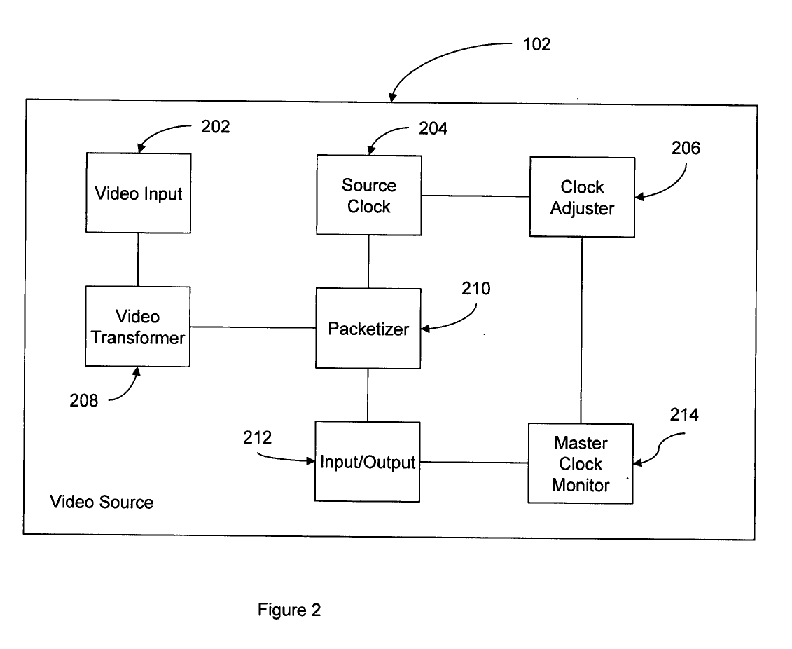

FIG. 2 illustrates an exemplary video source 200 in accordance with the system of FIG. 1. The video source 200 includes a video input 202, a source clock 204, a clock adjuster 206, a video transformer 208, a packetizer 210, an input/output interface 212, and a master clock monitor 214. The video input 202 receives a video signal such as, for example a serial digital interface signal (i.e., SDI). The video signal may be created by a video camera (not shown) that may form part of the video source 200 or may be remote to the video source 200. The video signal that is received by the video input 202 is forwarded to the video transformer 208, which converts the video signal into a format that is compatible with a packeted network. For example, the video transformer 208 may transform an SDI video signal into an MPEG-2 format video signal or the like.

MPEG is an acronym for the Moving Picture Experts Group which is charged with the development of video and audio encoding standards. MPEG has standardized several compression formats and ancillary standards, including, for example, MPEG-2, which is a transport, video and audio standard for broadcast-quality television.

The video transformer 208 forwards the transformed video signal to the packetizer 210. The packetizer 210 receives the transformed video signal and also receives a clock signal from the source clock 204. The packetizer 210 then encodes each packet of data with a time code and source ID in accordance with the signal from the source clock 204. The packetizer 210 then forwards the packeted, time stamped, video signal to the input/output for transmission onto the packeted network 104.

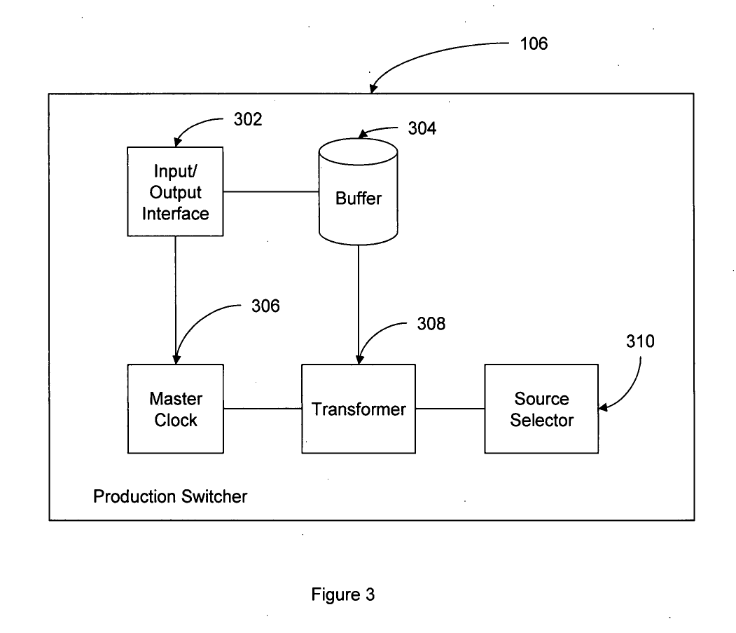

The video source 200 synchronizes the source clock 204 with a master clock 306 (FIG. 3) which is in communication with the video source 200 through the packeted network 104. As will be explained in more detail below, the master clock monitor 214 works with the clock adjuster 206 to synchronize the source clock 204 to the master clock. The master clock monitor 214 monitors the packeted network for timing packets from the master clock. The master clock monitor 214 calculates a propagation delay from the master clock to the video source 200 and forwards the calculated propagation delay to the clock adjuster 206. The clock adjuster 206 adjusts the source clock 204 in accordance with the calculated propagation delay.

All of these components may be integrated in future versions of cameras, tape recorders, video servers and the like, thereby obviating the need for external equipment.

The system 100 of the present invention also includes a production switcher 106. The production switcher 106 includes an input/output interface 302, a buffer 304, a master clock 306, a transformer 308, and a source selector 310. The input/output interface 302 is in communication with the packeted network 104 and receives the packeted video signal from the video source 102. The input/output interface 302 forwards the packeted video signal to the buffer 304. The buffer 304 stores the packeted video signal for processing by the transformer 308. The transformer 308 recreates the video signal from the packets that are stored in the buffer 304. For example, the transformer 308 may transform the packeted video signal from a MPEG-2 time-coded packeted signal to a serial digital interface (SDI) signal. The transformer 308, further, is capable of providing a transformed video signal that is synchronized with the master clock 306 in order to enable live video editing and production.

While the above-description describes the processing of only a single video signal, it is clear to those of ordinary skill in the art, that the production switcher 106 may be receiving multiple video signals from multiple video sources 102 and the transformer 308 may be creating multiple, synchronized, video signals. The source selector 310 selects between the multiple, synchronized video signals provided by the transformer 308.

The switcher can now synch up the content of different sources by analyzing the time codes included in the packets and buffering the signals so that the signals that are received first are correctly matched with the corresponding signals that are received later.

Although, not illustrated or discussed, those of ordinary skill in the art understand that the production switcher may incorporate many other features and/or structures which may be useful and/or desirable in a live video production system, such as, for example, fading, moving or wiping between video sources, creating all kinds of effects, like page turns, borders, and the like. These features are not discussed or illustrated because they are merely ancillary to the present invention and those of ordinary skill in the art understand that these additional features may be included and still practice the present invention.

Further, while the production switcher 106 includes a master clock 306, those of ordinary skill in the art understand that the master clock 306 does not need to form a part of the production switcher 106 and still form a part of the present invention. The master clock 306 only needs to be in communication with the packeted network 104 to provide time code packets with which the video sources may be synchronized. For example, in another exemplary embodiment of the present invention, the production switcher 106 may include features, similar to those features of the video source 102, which enable a clock (not shown) that is local to the production switcher 106 to be synchronized to the master clock as discussed above.

Indeed, in yet another exemplary embodiment, one of the source clocks 204 in one of the video sources 102 may serve as a master clock for other video sources 102 and the production switcher 106.

Alternatively, in another exemplary embodiment of the present invention, a master world clock may be designated to which all time codes may be adjusted to ensure synchronization. It is to be understood that any clock may be selected as the master clock as long as the content between the sources are synchronized.

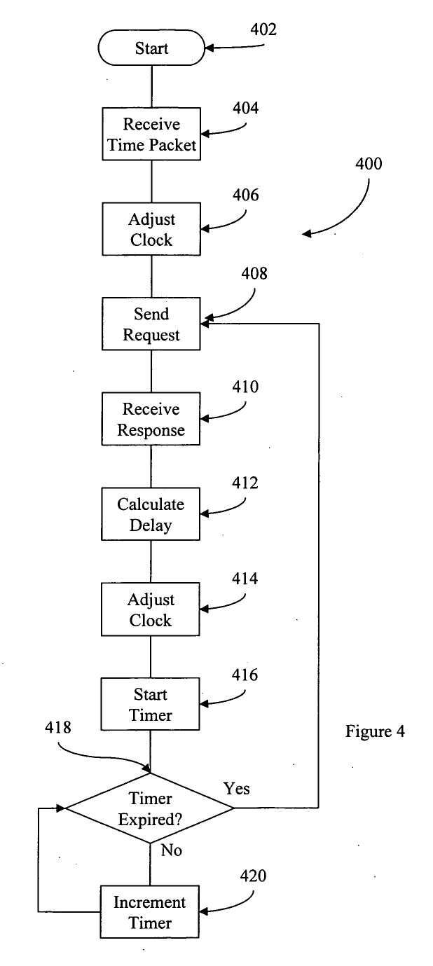

FIG. 4 illustrates a flowchart 400 for one exemplary method of synchronizing the time codes from a source clock 204 to a master clock 306 in accordance with one exemplary embodiment. The method starts as step 402 and continues to step 404. At step 404, the master clock monitor 204 of the video source 102 receives a time packet from the master clock 306 via the packeted network 104. Each timing packet includes a master clock identifier and a master clock network address. In step 406, the time code adjuster 206 adjusts the time code from the source clock 204 based upon the time encoded within the time packet for coarse synchronization.

In step 408, the master clock monitor 214 sends a request to the master clock 306 for another time encoded packet via the packeted network 104.

In step 410, the master clock monitor 214 receives a time encoded packeted response from the master clock 306 at the master clock monitor 214. This packet includes the reception time of the request packet by the master clock 306. In step 412, the master clock monitor 214 forwards the propagation delay received in the packet and the packets timestamp to the clock adjuster 206.

In another exemplary embodiment of the present invention, the master clock monitor 214 calculates forward and backward propagation delay from timing the roundtrip between the video source and the master clock and using the aforementioned delay calculated by the master clock monitor 214 and the timestamp in the return packet from the master clock 306 to discern between propagation to the master clock and from the master clock. In this manner, the latency in each direction may be determined. This information may be useful, for example, in networks having latencies that vary with respect to direction.

In step 414, the clock adjuster 206 adjusts the source clock based upon the calculated propagation delay, by adding the propagation delay to the current clock reading.

In step 416, a timer (not show) may be started and in step 418 the method determines whether a predetermined period of time has elapsed. If the predetermined period of time has not elapsed, then the method proceeds to step 420 where the timer is incremented.

Alternatively, if the method determines that the timer has expired (i.e., a predetermined period of time has elapsed) then the method returns to step 408. In this manner, the source clock 204 is periodically adjusted at regular intervals to ensure accurate tracking of the master clock 306.

In another exemplary embodiment, this process is repeated a number of times, periodically until an average propagation delay between the video source and the master clock is established to a reasonable certainty, such as, for example, 1 millisecond.

Alternatively, this adjustment process may be performed each time a timing packet from the master clock arrives outside a set window (i.e. period of time in which the timing packet is expected to arrive). In this manner, the video source may adjust its local clock to match the master clock with a high degree of accuracy, such as, for example, accuracy to within 1 millisecond.

Once the source clock has been adjusted, then the source clock provides time codes to the packets containing the video from the source. These time codes may then be used to reconstruct the video content from the source at a local server and to thereby synchronize the content from different video content sources.

An exemplary embodiment of the present invention may simplify the distribution of video sources for use by various video production systems. For example, a large scale sporting event, such as, for example, the Olympic games, may include multiple cameras at multiple locations throughout the site. Oftentimes, these multiple cameras are owned and controlled by a single company who is responsible for providing access to the video content being created by the multiple cameras to many other video production companies.

Conventionally, a video production company that desires to have access to that content was required to arrange with the camera company to physically patch into the camera company's video production system in order to obtain the desired video feeds. Typically, the right to the camera feeds is arranged through the contracting of various access rights. The rights holders may then patch into receive the corresponding camera feeds.

This patch is obtained by having a centralized video infrastructure with manpower and patch bays or routers, where cameras are physically patched through to the rights holders on separate lines of video.

In stark contrast, an exemplary embodiment of the present invention enables the camera video feed to be encrypted at the source and then provided on a readily accessible packeted network, such as, for example, the Internet. The rights holder may then obtain access to the corresponding feed by connecting to the network and then receiving the encrypted video signals. The rights holder would have received a key with which the encrypted video feed may then be decrypted and processed.

While others who are not rights holders may be able to obtain the same packeted data from the same camera feeds, those who are not rights holders would not be able to decrypt the video signals.

In one exemplary embodiment the Network Time Protocol (NTP), which is a protocol for synchronizing the clocks of computer systems over packet-switched, variable-latency data networks may be used. NTP does address propagation delay, it uses very similar methods to the one described above to synchronize clocks. However, the conventional Network Time Protocol requires a considerable implementation of over head because it requires an operating system.

In another exemplary embodiment of the present invention, the system may include a plurality of master clocks that are synchronized on the network. The same “discovery process” by the sources may be conducted based upon the timing packets received from each of the plurality of master clocks.

A source that does not reach a predetermined accuracy may still be processed by the local server, however, the video content from that source may result in “jumps” in content when switching between sources. For example, a lip sync may not be achieved, or a ball in a sports broadcast may jump around rather than transition smoothly through the video when switching cameras.

An exemplary embodiment of the present invention is format independent. In other words, the packeted network may transport, between the sources and the video switcher, any format of data that each are capable of processing.

Further, in an exemplary embodiment of the present invention, mixed environments are possible. For example, no specific video resolution or encoding is preferred. A mixed environment network is capable of transporting all embodiments of video, the endpoints have to decode/recode the content.

In an exemplary embodiment of the present invention, the video source provides a unique field identification tag to each packet which identifies the data within that packet as corresponding to a particular field of footage.

In another exemplary embodiment of the present invention a list of last edits device/time/date could be implemented. For example, video could include information on when, how and where it was used to create edits, etc. This embodiment allows tracking the footage back to its source.

Another exemplary embodiment of the present invention provides watermarks at the device level. Watermarking is a process of including invisible information into the picture itself, which is used to identify the original owner (or recipient) of the video. This embodiment may include a computer to do the necessary video encoding.

Yet another exemplary embodiment of the present invention may generate lower bandwidth, preview versions of live content. Such an embodiment may be particularly useful in the context of mobile applications where bandwidth is limited. This embodiment may further provide multiple versions of content each having a different level of bandwidth.

An exemplary embodiment of the present invention is capable of synchronizing both in video framing and real time for timed cuts between streams and synched events (e.g., overlay of graphics, video effects using multiple sources, etc.). For example, the real time content in a picture taken by a camera may be synchronized to a graphic, e.g. the graphical border on slow-motion tricks, things happening in a virtual studio, etc. This embodiment may enable inserting of information (e.g., metadata) into the video stream.

An exemplary embodiment of the present invention may incorporate digital rights management and encryption technologies. In this manner, a video source may encrypt the video signal packets being provided onto the packeted network and may provide a key for decrypting the content to entities which have acquired rights to the content. Such a system enables live video production over packeted networks to provide content to a large number of rights holders.

Further, an exemplary embodiment of the present invention may incorporate metadata into the packeted data in addition to the synchronized time codes to provide additional information which is not available with conventional transport technologies. For example, a video source may include content related to a particular sporting event and the video source may incorporate metadata regarding that content such as, for example, scouting information at sports productions, camera perspective from motion heads/lenses, motion control data, actor tracking, and the like.

Yet another exemplary embodiment of the present invention enables a bidirectional stream of content without adding cost to the infrastructure. For example, the production switcher may be provided with additional control capabilities which may permit control and/or other information to flow from the production switcher to the video source. This return flow of information may permit, for example, replacement of a Triax for camera hookup, reverse pictures, audio, tally and talkback through Internet protocol and the like.

Another exemplary embodiment of the present invention includes a network master that keeps a map of the topology, broadcasts clock time codes, and synchronizes the time codes from the nodes. This network master may serve as a central instance for subscribing feeds, verifying users/devices, provide for integration into DNS/Active directory/LDAP, manage access rights to devices (to provide security and to prevent configuration changes of intruders or personnel without the necessary rights). The network master may be redundant by being resident upon, for example, two computers.

Another exemplary embodiment of the present invention, includes a key manager if encrypted streams are used. Such an embodiment may relate to the integration of the video production network into existing computer infrastructure. This exemplary embodiment may easily be tied into an existing system for user management and such. This embodiment enables the video sources to share information about users and their rights. With this embodiment a user could, for example, create a login at a switcher console, which would use the user's current password and would only allow the user to operate certain settings and capabilities of the switcher. The related passwords and rights may be stored in a company's standard infrastructure, while the video sources may act as “normal” network devices. Also, for central management of all the systems, a master computer keeping all the information about the connected devices and their status may also be incorporated into this embodiment. Such a master computer may act as a central management console for the production system, e.g. configuring all the ports and switches employed, showing faults in attached devices, etc.

Yet another exemplary embodiment of the present invention provides direct interfacing to video servers through a small piece of software on the server which converts from the servers video encoding format to the format used on the network (server side packetizer).

An exemplary embodiment of the present invention enables the construction of modular switch panels. Such an embodiment may include as many mix/effects as are desired in any configuration. Only a maximum number of concurrently used sources/outputs needs to be cabled as available bandwidth.

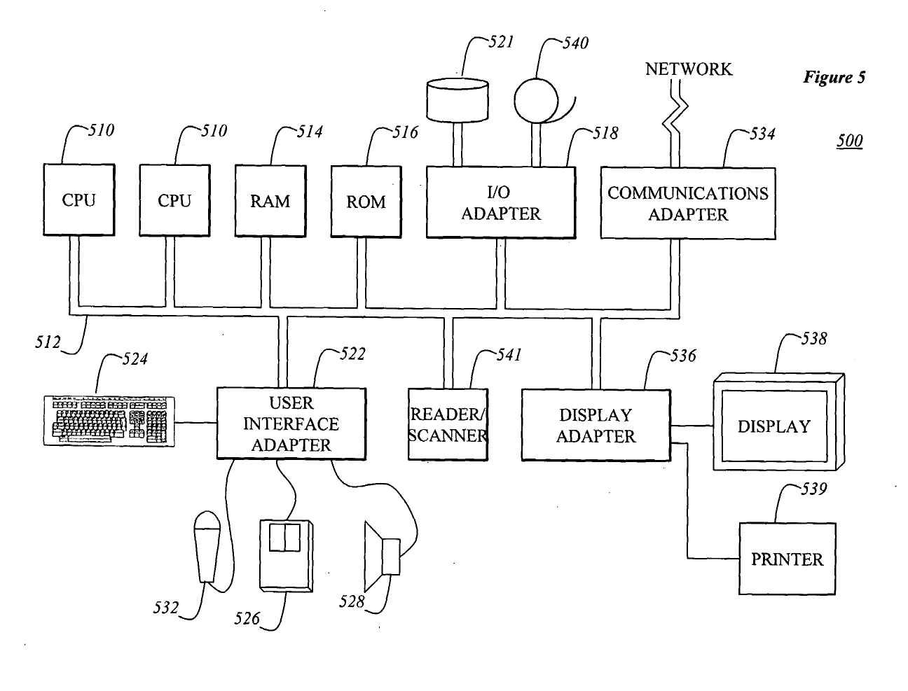

FIG. 5 illustrates a typical hardware configuration of an information handling/computer system for use with the invention and which preferably has at least one processor or central processing unit (CPU) 511.

The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communication adapter 534 for connecting an information handling system to a data processing network, the Internet, an Intranet, a personal area network (PAN), etc., and a display adapter 536 for connecting the bus 512 to a display device 538 and/or printer.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

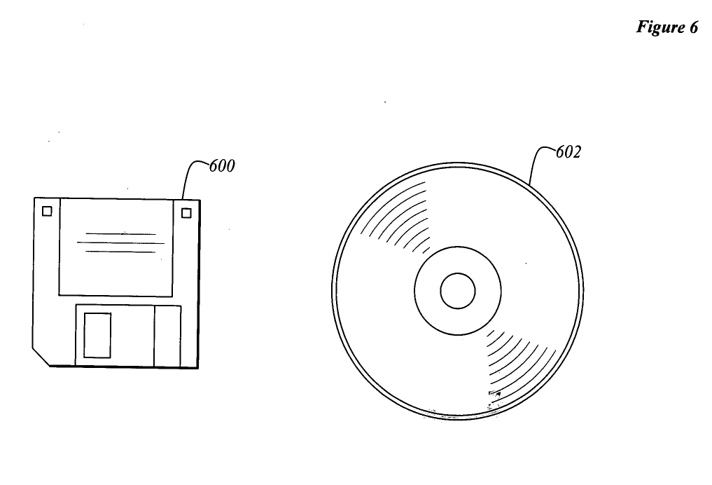

This signal-bearing media may include, for example, a RAM contained within the CPU 511, as represented by the fast-access storage for example. Alternatively, the instructions may be contained in another signal-bearing media, such as a magnetic data storage diskette 600 (FIG. 6), directly or indirectly accessible by the CPU 511.

Whether contained in the diskette 600, the computer/CPU 511, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

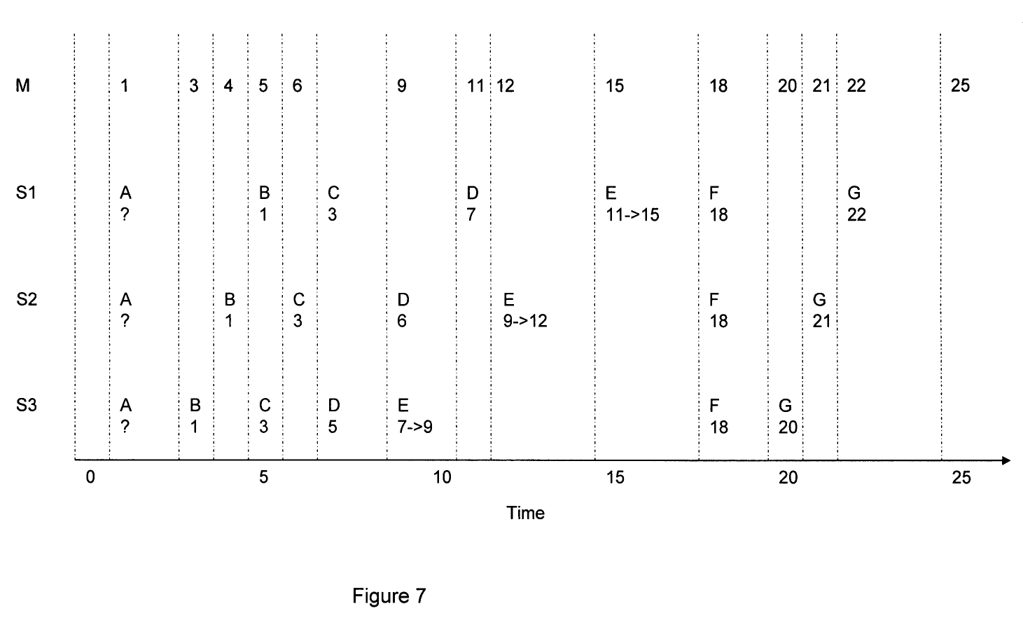

FIG. 7 illustrates a timeline of an example of the operation of one exemplary embodiment of the present invention. The timeline illustrates how the present invention is capable of synchronizing three separate source clocks S1, S2, and S3, to a master clock M. The timeline provides the current values that are held by the four clocks as the present invention synchronizes the clocks. For the purposes of this illustration the values of the master clock M correspond to the “absolute” time values along the time axis of the time line.

The timeline starts at time “1” where the master clock M holds a value of “1”, while the values held by the source clocks S1, S2, and S3, are unknown (i.e., “?”). This starting point is represented as point “A”, which corresponds to step 402 in the flowchart of FIG. 4. The master clock M sends a packet having a time code of “1” to the network.

Steps 404 and 406 of the flowchart for each of the source clocks S1, S2, and S3, are indicated by “B” along the time line. For each of the clocks, at “B”, the clocks receive the packet from the master clock. Since the clocks reside on a network which has a variable latency, the packet arrives at each of the source clocks at different times. For example, the packet arrives at source clock S3 at a master clock time of “3”, the packet arrives at source clock S2 at a master clock time “4”, and the packet arrives at source clock S1 at a master clock time of “5”.

As is clearly illustrated by the time line, when the packet from the master clock arrives at each source clock, the source clock is adjusted to match the time code in the packet. Therefore, each of the source clocks set their clock to a value of “1” at the stage in the process represented as “B” along the time line and in accordance with step 406 of FIG. 4.

In the next stage at “C”, each of the source clocks send a request back to the master clock M in accordance with step 408 of FIG. 4. The packet includes a time code which indicates the time indicated by the source clock upon creation of the packet. In this example, each of the source clocks generate a packet when the corresponding source clock indicates a time of “3”. Therefore, the request includes a time code of “3” for each of the clocks.

In the next stage of the time line at “D”, the master clock receives the packet from each of the source clocks and sends back another packet with a time code indicating the current time value of the master clock. In the example of FIG. 7, the master clock M receives a request from source clock S3 at a master clock value of “7”. Therefore, the master clock M sends a response back to the source clock S3 with a master time code of “7”.

Similarly, the master clock M receives a request from source clock S2 at a master clock value of “9” and sends a response back to the source clock S2 with a master time code of “9” and the master clock M receives a request from source clock S1 at a master clock value of “11” and sends a response back to the source clock S1 with a master time code of “11”.

In the next stage “E” of the time line, the respective source clocks execute steps 410-414 of FIG. 4 to adjust the source clock so that the source clock is synchronized to the master clock.

For example, the source clock S3 calculates the propagation delay from the source clock S3 to the master clock by subtracting the time code in the request that was sent to the master clock M by the source clock from the current source clock S3 value and divides that number by two. In this example, the source clock S3 had a time code of “3” and received a master time code of “7”, thus, the propagation delay is (7−3)/2=2.

The source clock S3 then adds the value of the propagation delay to the current value of the source clock S3. In this example, the current value of the source clock S3 is 7, so adding the propagation delay value of 2 to the current value of 7 yields a value of 9. The source clock S3 is then adjusted to the value of 9. In this manner, the source clock S3 is synchronized to the master clock M.

Similarly, the source clocks S1 and S2 receive time codes from the master clock and adjust their values from 9 to 12, and from 11 to 15, respectively.

Now that the source clocks S1, S2, and S3, are all synchronized to the master clock M, content which is captured simultaneously at event “F”, are all packaged within packets having the same time code which indicates the same time value of “18”. Thus, when the respective time packets are received by the master clock at different times, a production switch is able to synchronize the content from each of the sources. For example, despite the fact that the content which was captured at a time of “18” arrives from source clock S1 at an absolute time of “22”, arrives from the source clock S2 at an absolute time of “21,” and arrives from source clock S1 at an absolute time of “20” all of the packets contain a time code which indicates a synchronized time of “18” and, therefore, despite the varying delayed arrival times, the switch may re-synchronize the content using the time codes.

While the invention has been described in terms of several exemplary embodiments, those skilled in the art will recognize that the invention can be practiced with modification.

Further, it is noted that, Applicant's intent is to encompass equivalents of all claim elements, even if amended later during prosecution.

What is claimed is:

1. A system for live video production on video signals over a packeted network, the system comprising:
a master clock providing a packeted time code signal to the packeted network; and
a video source having a source clock that is synchronized to the master clock based upon said packeted time code signal from the master clock.

2. The system of claim 1, wherein said source clock is synchronized based upon a propagation delay between said video source and said master clock across said packeted network.

3. The system of claim 2, wherein said video source is repeatedly synchronized until an average of propagation delay reaches a predetermined level of certainty.

4. The system of claim 2, wherein said video source is synchronized again if a packeted time code signal from said master clock arrives at said video source outside of a predetermined range of time.

5. The system of claim 1, wherein said video source provides a packet, including a video signal and video source clock time code, to said packeted network.

6. The system of claim 5, wherein said packet further comprises a video source identification code.

7. The system of claim 5, wherein said packet further comprises metadata about said video signal.

8. The system of claim 5, wherein said packet further comprises data regarding a condition of said video source.

9. The system of claim 5, wherein said video signal is encoded within said packet.

10. The system of claim 5, wherein said video signal comprises a watermarked video signal.

11. The system of claim 5, wherein said video source comprises a plurality of said video sources.

12. The system of claim 11, wherein said master clock comprises one of said plurality of video source clocks.

13. The system of claim 11, further comprising a production switch that receives packeted video signals from each of said plurality of video sources.

14. The system of claim 13, wherein said production switch produces a video signal based upon said packeted video signals by synchronizing said video signals based upon said packeted time code signals.

15. The system of claim 1, wherein said video source is synchronized periodically.

16. The system of claim 1, wherein said video source is synchronized repeatedly until an adjustment to said source clock is less than a predetermined amount.

17. The system of claim 1, wherein said packeted network comprises an Ethernet network.

18. The system of claim 1, wherein said packeted network comprises the Internet.

19. A video source for use in live video production on video signals over a packeted network, the source comprising:
a source clock; and
a clock adjuster that adjusts said source clock based upon a propagation delay between said video source and a master clock across the packeted network.

20. A video production switch for use in live video production on video signals received via a packeted network, the switch comprising:
a buffer that receives video signal packets from a plurality of video sources via the packeted network, wherein said video signal packets comprise a time code that indicates a time indicated by a corresponding video source clock; and
a transformer that synchronizes the video signals from the video signal packets based upon the time codes.

21. A method for live video production on video signals over a packeted network, the method comprising:
providing a packeted master clock time code to the packeted network from a master clock; and
synchronizing a video source clock at a video source to said master clock based upon said packeted master clock time code.

22. The method of claim 21, wherein said synchronizing said video source clock comprises determining a propagation delay between said master clock and said video source clock over said packeted network.

23. The method of claim 22, wherein said determining said propagation delay comprises:
receiving said packeted master clock time code at said video source clock;
adjusting said video source clock based upon said packeted master clock time code;
sending a request packet including a first time code from said video source clock to said master clock;
receiving a response from said master clock at said video source clock;
determining a propagation delay based upon said first time code and a current time of said video source clock; and
adjusting said video source clock based upon said propagation delay.

24. The method of claim 22, wherein said adjusting said video source clock comprises adding said propagation delay to said current time of said video source clock.

25. The method of claim 21, further comprising providing a synchronized packeted video signal to said packeted network from said video source.

26. The method of claim 21, wherein said video source comprises a plurality of video sources, and wherein said master clock comprises one of said plurality of video source clocks, the method further comprising receiving a packeted video signal and time code from each of said plurality of video sources at a production switch.

27. The method of claim 28, further comprising producing a synchronized video signal at said production switch based upon said plurality of packeted video signals and time codes.

28. A method for live video production on video signals over a packeted network, the method comprising:
providing a packeted master clock time code to the packeted network from a master clock;
determining a propagation delay across said packeted network between said master clock to a video source; and
synchronizing a video source clock at the video source to said master clock based upon said propagation delay.

29. The method of claim 28, wherein video source comprises one of a remote and a local unsynchronized video source.

30. The method of claim 29, wherein the time code is embedded in the network.

31. A method for live video production on video signals over a packeted network, the method comprising:
providing a packeted master clock time code to the packeted network from a master clock;
determining a propagation delay from a first video source to a production switch based upon said time code and an arrival time of a video signal from said first video source; and
synchronizing the video signal from said first video source at said production switch to a second video signal received from a second video source.
